(19) United States
(12) Patent Application Publication
(10) Pub. No.: US 2024/0197116 A1
(43) Pub. Date: Jun. 20, 2024

(54) DEVICE FOR TILTING A DRUM OF A WET GRINDER

(71) Applicant: VERSUNI HOLDING B.V., Eindhoven (NL)

(72) Inventor: Satish Kumar UPPU, Eindhoven (NL)

(73) Assignee: VERSUNI HOLDING B.V., Eindhoven (NL)

(21) Appl. No.: 18/544,147

(22) Filed: Dec. 18, 2023

(30) Foreign Application Priority Data
Dec. 16, 2022 (IN) 202241072758

(51) Int. Cl. A47J 43/07

(52) U.S. Cl. CPC A47J 43/0716

(57) ABSTRACT

Present disclosure relates to a device for tilting a drum of a wet grinder for extracting content from the drum. The wet grinder includes a body which is defined with a base that accommodates a bottom portion of the drum and a support member, which extends upwardly away from one end of the base. The support member supports a circumferential portion of the drum. Further, the body is operable between a first position and a second position to selectively tilt the drum to extract the content from the drum. The configuration of the device aids in accommodating the drum of the wet grinder and titling of the drum. That is, the device is operable by a user from the first position to the second position, along with which the drum also tilts, which aids in easy and quick extraction of the content from the drum.

### CROSS-REFERENCE TO RELATED APPLICATIONS

The present application is a U.S. Convention application under 35 U.S.C. § 119 of Indian Application No. 202241072758, filed on Dec. 16, 2022.

### TECHNICAL FIELD

Present disclosure generally relates to an electro-mechanical appliance. Particularly, but not exclusively the present disclosure relates to a wet grinder. Further, embodiments of the present disclosure, discloses a device for tilting a drum of the wet grinder.

### BACKGROUND

Food processing units are widely used for a variety of food processing activities such as grinding, blending, mixing, kneading and the like. Usually, these food processing units are motor driven, which are capable of processing food in a variety of forms as mentioned above. One such food processing unit, which is widely adapted to process food in substantially large quantities is a wet grinder. The wet grinder is an electric stone mill, which is used to grind ingredients to create fine and coarse batter. Generally, wet grinders include a disc-shaped stone fixed to an inner bottom surface of a rotatable metal cylindrical drum, and a plurality of rollers are mounted on the drum stone, where the plurality of roller stones rotate relative to rotation of the metal cylindrical drum. Therefore, ingredients such as grains (such as rice) soaked in water, are introduced into the drum and the drum is rotated, so that the grains are ground between the rotating drum stone and the roller stones, to form batter.

In conventional wet grinders, batter is extracted from the drum manually either using hand or a scooping tool. Such extraction makes the batter extraction cumbersome and time consuming which is undesired. Further, with advent of new technology, the wet grinder including a mechanism for tilting the drum have been developed. The mechanism helps in tilting the drum to facilitate easy scooping of the batter out of the drum. However, such mechanisms are integrated with the wet grinders and in order to avail such tilting benefit, a new wet grinder having tilting feature has to be bought. This leads to additional investment and maintenance cost, which is again undesired.

The present disclosure is directed to overcome one or more limitations stated above or any other limitations associated with the known arts.

### SUMMARY OF THE DISCLOSURE

It is an objective to provide a device, which can be used to accommodate a drum of a normal wet grinder (i.e., wet grinders without tilting mechanism) to facilitate titling of the drum for easy and faster extraction of content from the drum. Therefore, the device aids in providing a feature of tilting the drum of the normal wet grinders.

To better address one or more of these concerns, in a first aspect of the disclosure there is provided a device for tilting a drum of a wet grinder for extracting content from the drum. The wet grinder includes a body which is defined with a base configured to accommodate a bottom portion of the drum. Further, the body is defined with a support member, which extends upwardly away from one end of the base. The support member is defined with an inner surface and an outer surface. The inner surface is configured to support a circumferential portion of the drum. Further, the body is operable between a first position and a second position to selectively tilt the drum to extract the content from the drum. The configuration of the device aids in accommodating the drum of the wet grinder and titling of the drum. That is, the device is operable by the user from the first position to the second position, along with which the drum also tilts, which aids in easy and quick extraction (thus, scooping) of the content from the drum.

In an embodiment, the device includes at least one hook defined on an end of the support member. The at least one hook is configured to engage a brim portion of the drum for locking the drum. Locking the drum aids in gripping the drum with the device during operation of the device between the first position and the second position, and extracting of the content from the drum.

In an embodiment, the device includes an adjoining portion between the one end of the base and the support member. The adjoining portion is defined with a curved profile. The curved profile aids in smooth operation of the device between the first position and the second position. Further, the curved profile is covered with an anti-slip padding. The anti-slip padding provides frictional grip to the device during operation of the device between the first position and the second position.

In an embodiment, the inner surface of the support member includes a first portion. The first portion is defined with a first curvature relative to the base. Further, the support member includes a second portion. The second portion is defined with a second curvature relative to the base. The first curvature and the second curvature aids in positioning different sized drums on to the device.

In an embodiment, the device includes a plurality of anti-slip paddings disposed on the inner surface and the outer surface of the support member. The plurality of anti-slip paddings aids in gripping the drum with the inner surface of the support member and gripping the outer surface of the device on a table top, in its second position.

In an embodiment, the device includes a plurality of bushings coupled to a bottom surface of the base and the outer surface of the support member. The plurality of bushings aids in gripping the device in the first position and the second position on the table top.

In an embodiment, the base and the inner surface of the support member is defined with a tapered surface. The tapered surface aids in further inclining the drum in the tilted position, corresponding to the body (thus, the device) in its second position and also securely positioning the drum on the device.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF ACCOMPANYING DRAWINGS

The novel features and characteristic of the disclosure are set forth in the appended claims. The disclosure itself, however, as well as a mode of use, further objectives and advantages thereof, will best be understood by reference to the following detailed description of an embodiment when read in conjunction with the accompanying drawings. One or more embodiments are now described, by way of example only, with reference to the accompanying drawings wherein like reference numerals represent like elements and in which:

FIG. 1 illustrates a top perspective view of a device, in accordance with an embodiment of the present disclosure.

FIG. 2 illustrates a bottom perspective view of the device, in accordance with an embodiment of the present disclosure.

FIG. 3 illustrates another front perspective view of the device, in accordance with an embodiment of the present disclosure.

FIG. 4 illustrates a perspective view of the device accommodating a drum and depicting a first position of the device, in accordance with an embodiment of the present disclosure.

FIG. 5 illustrates a perspective view of the device accommodating the drum and depicting a second position of the device, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

While the embodiments in the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is to cover all modifications, equivalents, and alternative falling within the scope of the disclosure.

It is to be noted that a person skilled in the art would be motivated from the present disclosure and modify various features of a device for tilting a drum of a wet grinder. Therefore, such modifications are considered to be part of the disclosure. Accordingly, the drawings show only those specific details that are pertinent to understand the embodiments of the present disclosure, so as not to obscure the disclosure with details that will be readily apparent to those of ordinary skilled in the art having benefit of the description herein.

The terms “comprises”, “comprising”, or any other variations thereof used in the disclosure, are intended to cover a non-exclusive inclusion, such that a device that comprises a list of components does not include only those components but may include other components not expressly listed or inherent to such system, method, or assembly, or device. In other words, one or more elements in a system or device proceeded by “comprises . . . a” does not, without more constraints, preclude the existence of other elements or additional elements in the system or device.

In the following detailed description, embodiments of the disclosure are explained with reference to accompanying figures that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

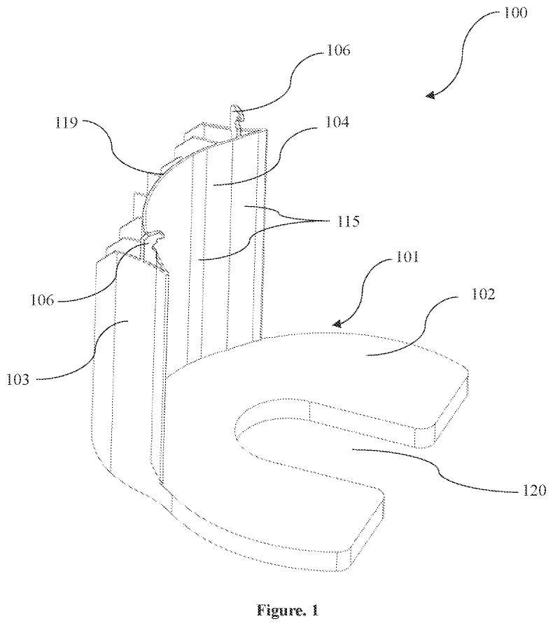

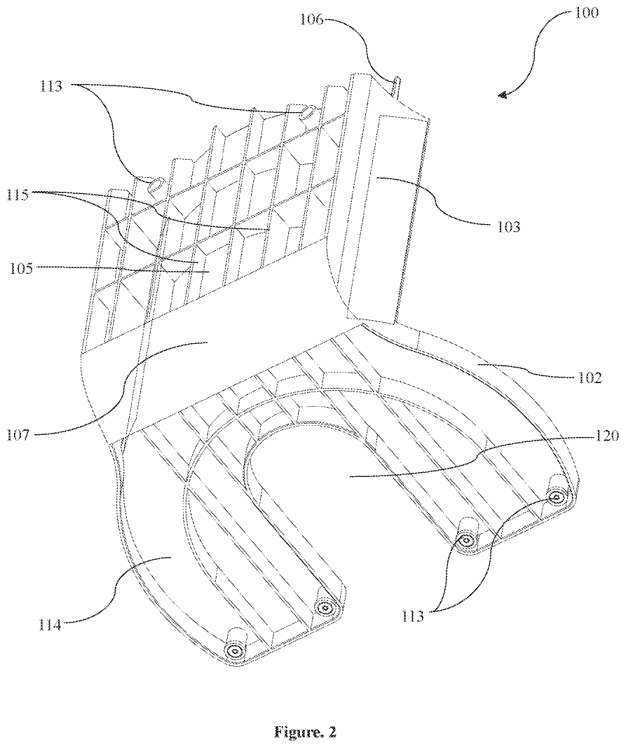

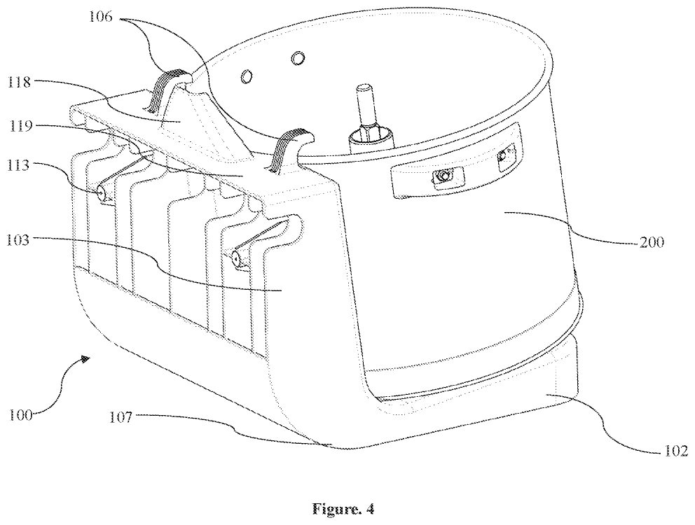

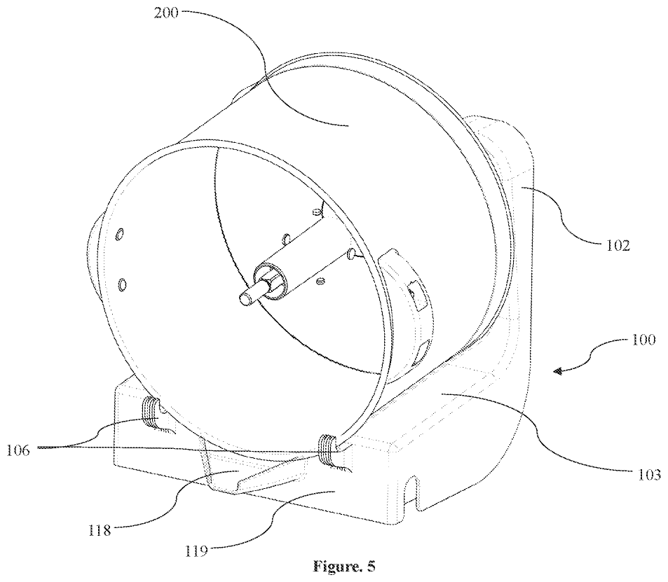

FIGS. 1 and 2 illustrates a top perspective view and a bottom perspective view of a device for tilting a drum [as seen in FIGS. 4 and 5] of a wet grinder [not shown in Figures], to desired positions. As seen in FIG. 1, the device may include a body which may be defined with a base and a support member extending upwardly away from one end of the base. The body [thus, the device (100)] may be operable between a first position [as seen in FIG. 4] and a second position [as seen in FIG. 5] for selectively tilting the drum of the wet grinder. In an embodiment, the support member integrally extend from the one end of the base, thus making the body [thus, the device (100)] an unitary structure. Further, the support member may be defined with an inner surface and an outer surface. As seen in FIG. 4, the base may be configured to accommodate a bottom portion of the drum and the inner surface of the support member may be configured to support a circumferential portion of the drum. In an embodiment, as best seen in FIG. 2, the device may include an adjoining portion between the one end of the base and the support member.

The adjoining portion may be defined with a curved profile to facilitate easy and smooth operation of the body between the first position and the second position. Further, in an embodiment, the device may include a plurality of anti-slip paddings. The plurality of anti-slip paddings may be disposed on the inner surface and the outer surface of the support member. The anti-slip paddings disposed on the inner surface may aid in providing frictional grip to the circumferential portion of the drum, which is contacting the inner surface (104). Further, the anti-slip paddings disposed on the outer surface may aid in providing friction grip to the body [thus, the device (100)] when the device is operated to the second position. Further, in an embodiment, the device may include a plurality of bushings (113) which may be coupled to a bottom surface (114) of the base and the outer surface of the support member. The bushings (113) on the bottom surface (114) of the base aids in gripping the device on a table top [not shown in Figures] in its first position and the bushings (113) on the outer surface of the support member may aid in gripping of the device on the table top, when the device is positioned in the second position. As an example, the anti-slipping pads and the bushings (113) may be manufactured of polymeric material such as silicone.

In an embodiment, the base may be defined with a cut-out (120) which may be configured to receive components such as coupler (not shown in Figures) which may extend away from the bottom portion of the drum.

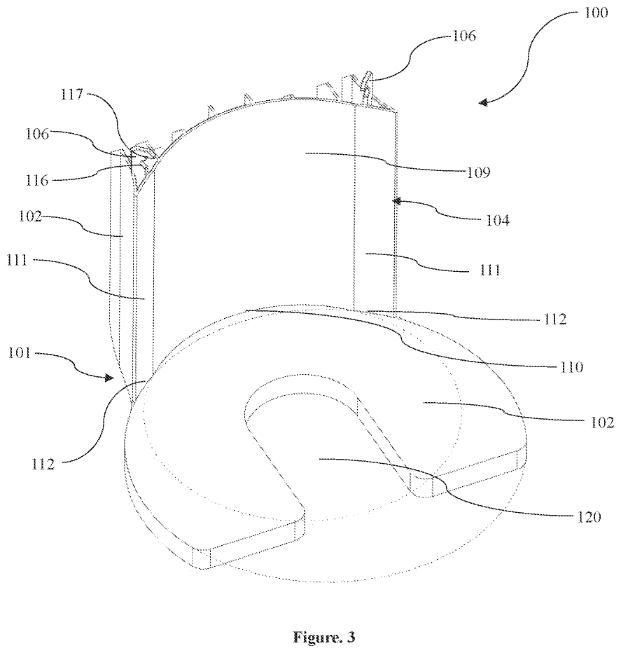

Referring further to FIG. 1, the device may include at least one hook defined on an end of the support member. The at least one hook may be configured to engage with a brim portion of the drum for locking the drum with the body. Locking of the drum by the at least one hook may prevent slipping of the drum from the device (100), when the device is operated to the second position. In an embodiment, as best seen in FIG. 3, the at least one hook may include a semi-circled groove (116) and a stepped portion (117). The semi-circled groove (116) may engage with the brim of the drum and the stepped portion (117) may extend over the brim. The stepped portion (117) may engage with the brim of the drum for locking the drum with the device to prevent slipping of the drum from the semi-circle groove (116). Therefore, the at least one hook provides two-stages of engagement and thus locking of the drum with the device (100), thus ensuring safety during extraction of the content (thus, ingredients or batter) from the drum.

Referring now to FIG. 3, the inner surface of the support member may include a first portion. The first portion may be defined with a first curvature relative to the base. The first curvature may aid in supporting the drum of a desired size. Further, the inner surface of the support member may include a second portion. In an illustrated embodiment, the second curvature may be defined on either sides of the first portion. The second curvature may aid in supporting a drum which may be of different size than that of the size of the drum supported by the first curvature. Thus the configuration of the device aids in accommodating different sized drums.

In an embodiment, as seen in FIG. 4, the base and the inner surface of the support member may be defined with a tapered surface. The tapered surface causes the centre of gravity (CG) of the drum and the device to shift further inside. This gives more stability to the device when the device is operated to the second position for tilting the drum to extract the content from the drum. Further, the tapered surface aids in inclining the drum more towards the ground due to which the gravity also aids in extracting the content from the drum. In an embodiment, the device may include a guiding chamber (118) which may be defined on the top portion (119) of the support member. The guiding chamber (118) may aid in channelizing the content out of the drum, when the drum is positioned in the inclined position.

In and embodiment, the guiding chamber (118) may be detachable and may be coupled to device for guiding the content during extraction of the content out of the drum.

In an embodiment, the device may be manufactured of but not limiting to a polymeric material.

In an operational embodiment, to extract content from the drum of the wet grinder, the drum may be removed from the wet grinder and may be positioned in the device (100). That is, the bottom portion of the drum may be positioned on the base and subsequently a circumferential portion may contact with the inner surface of the support member and the at least one hook may engage with the brim of the drum, thereby locking the drum with the device (100). In an embodiment, during placing of the drum in the device (100), the device is positioned in the first position [as seen in FIG. 4]. Upon positioning the drum on the device (100), the device may be operated from the first position to the second position [as seen in FIG. 5]. The curved adjoining portion of the device aids in smooth operation of the device from the first position to the second position. Once the device is operated to the second position, the user may scoop the content from the drum in an efficient manner as the inclined position of the drum aids easy and quick scooping of the content from the drum.

In an embodiment, the device may be coupled to an actuator (not shown in Figures). The actuator may be actuated to operate the device between the first position and the second position.

In and embodiment, the device may include a handle (not shown in Figures) which may be defined on a top portion (119) of the support member. The handle may aid is easy operation of the device between the first position and the second position.

In an embodiment, the device is simple in construction and aids in effortless and faster extraction of the content from the drum.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

We claim:

1. A device for tilting a drum-of a wet grinder for extracting content from the drum, the device comprising:
a body, defined with:
a base configured to accommodate a bottom portion of the drum; and
a support member extending upwardly away from one end of the base, the support member is defined with an inner surface and an outer surface, wherein the inner surface is configured to support a circumferential portion of the drum,
wherein, the body-is operable between a first position and a second position to selectively tilt the drum-to extract the content from the drum.

2. The device of claim 1, further comprising at least one hook-defined on an end of the support member, wherein the at least one hook-is configured to engage a brim portion of the drum-for locking the drum.

3. The device of claim 1, further comprising an adjoining portion between the one end of the base and the support member, wherein the adjoining portion is defined with a curved profile.

4. The device of claim 3, wherein the curved profile is covered with an anti-slip padding.

5. The device of claim 1, wherein the inner surface of the support member comprises a first portion, the first portion-is defined with a first curvature-relative to the base.

6. The device of claim 5, wherein the inner surface of the support member further comprises a second portion, the second portion-is defined with a second curvature-relative to the base.

7. The device of claim 1, further comprising a plurality of anti-slip paddings disposed on the inner surface and the outer surface-of the support member.

8. The device of claim 1, further comprising a plurality of bushings coupled to a bottom surface of the base and the outer surface-of the support member.

9. The device of claim 1, wherein the base and the inner surface of the support member is defined with a tapered surface for inclining the drum in a tilted position of the drum corresponding to operation of the body between the first position and the second position.
